(19) United States
(12) Patent Application Publication
(10) Pub. No.: US 2005/0247724 A1
(43) Pub. Date: Nov. 10, 2005

(54) Cover dispenser

(76) Inventor: Robert J. Gapp, Northfield, IL (US)

Correspondence Address: WELSH & KATZ, LTD, 120 S RIVERSIDE PLAZA, 22ND FLOOR, CHICAGO, IL, 60606, US

(21) Appl. No.: 11/034,424

(22) Filed: Jan. 12, 2005

Related U.S. Application Data
(60) Provisional application No. 60/569,184, filed on May 7, 2004.

(51) Int. Cl. B65H 1/08; B65H 3/28; B65G 59/00; G07F 11/16

(52) U.S. Cl. 221/279

(57) ABSTRACT

A cover or lid dispensing mechanism includes an elongated cover or lid storage member which might be spring biased. The member has an open proximal end through which the respective covers or lids can be removed, one at a time. The end is covered by a planar dispensing mechanism which retains a stack of lids or covers in the storage element, while at the same time providing access to the next lid or cover to be removed from the stack.

### CROSS REFERENCE TO RELATED APPLICATION

This application claims the benefit of the filing date of U.S. Provisional Application No. 60/569,184 filed May 7, 2004, entitled “Lid Dispenser”.

### FIELD OF THE INVENTION

The invention pertains to packaging dispensing devices. More particularly, the invention pertains to cover dispensing devices.

### BACKGROUND OF THE INVENTION

A variety of dispensers for covers for food product containers are known. Typical of these are covers for cylindrical cups or containers for soup and the like. Some of the known containers are gravity fed. They include a cylindrical tube like structure with an open top into which a stack of covers or lids can be loaded.

The tubular member can include a slot which exposes the stack of lids or containers in part. Removal of a lid or cover is affected by lifting the topmost cover or lid off the stack, via the slot, through the opening.

Known cover or lid dispensers, while relatively simple in construction, may not rotate those covers or lids at the bottom of the stack out of the dispenser in a timely fashion, since they may not be available to be removed from the dispenser until all of the containers or lids which are stacked above them in the dispenser have been removed. If the dispenser is refilled before being completely empty, the bottom of the stack of lids or covers may remain in the dispenser for an extended period of time.

Alternately, a stack of covers may be provided which not only exposes the top covers for removal but also exposes additional covers in the stack to contact each time a top-most cover is removed. This configuration is thus undesirable from a sanitary point of view. It can also lead to wasted lids.

There is a continuing need for cover or lid dispensers which can present a single cover or lid at a time in a sanitary fashion to an individual for dispensing. There is also a continuing need for dispensers which not only retain the respective covers or lids in a closed, clean environment to make them attractive for customers, but also enable the dispenser to be arranged in a variety of orientations, depending on available cabinet space and the like.

### BRIEF DESCRIPTION OF THE DRAWINGS

FIG. 1 is an isometric view of a dispenser in accordance with the invention;

FIG. 2 is an enlarged partial view of the dispensing mechanism of the dispenser of FIG. 1;

FIG. 3 is a sectional view taken along plane 3-3 of FIG. 1;

FIG. 4 is a sectional view taken along plane 4-4 of FIG. 2;

FIG. 5 is a view of an alternate dispensing mechanism usable with the dispenser of FIG. 1; and

FIG. 6 is a view of yet another alternate dispensing mechanism usable with the dispenser of FIG. 1.

### DETAILED DESCRIPTION OF THE INVENTION

While embodiments of this invention can take many different forms, specific embodiments thereof are shown in the drawings and will be described herein in detail with the understanding that the present disclosure is to be considered as an exemplification of the principles of the invention, as well as the best mode of practicing same, and is not intended to limit the invention to the specific embodiment illustrated.

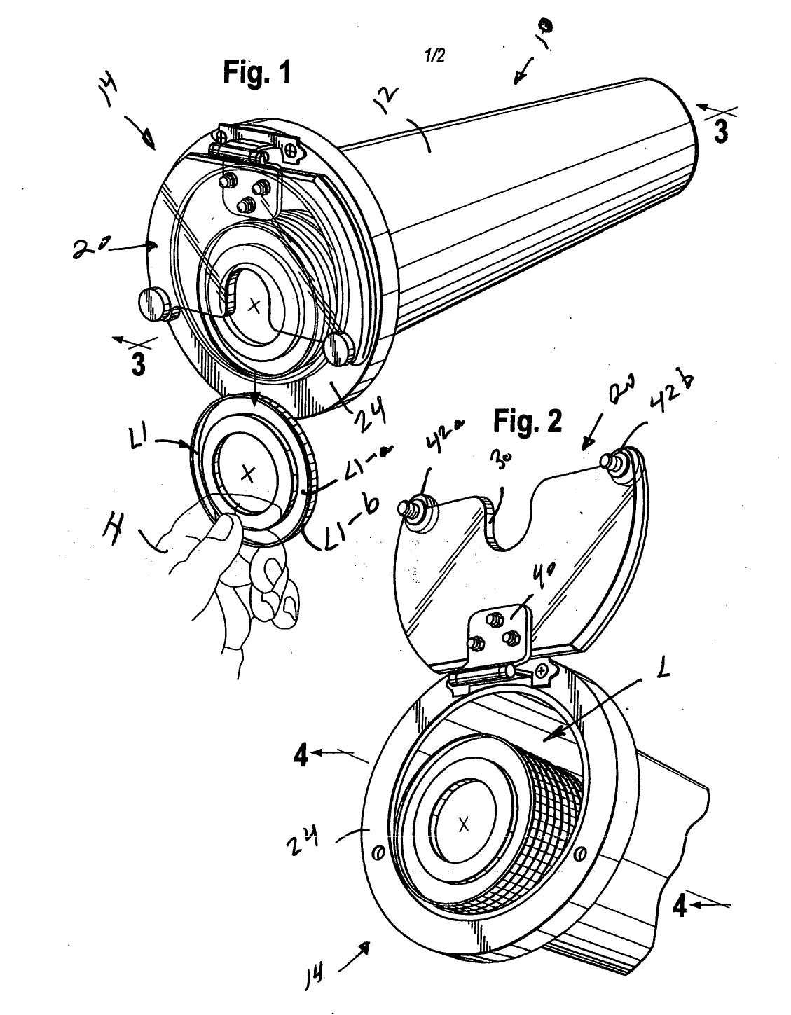

FIGS. 1-6 disclose various embodiments of the subject invention. In disclosed embodiments, the covers or lids are presented one at a time in a sanitary fashion for removal. Only the lid to be dispensed is readily accessible.

As illustrated in FIGS. 1-4, a lid dispenser 10 includes a cylindrical hollow body portion 12 having a lid loading/feeding end indicated generally at 14. The end 14 carries a lid dispensing cover structure indicated generally at 20, 20a (relative to FIG. 5) and 20b (relative to FIG. 6).

The structure 20, 20a, 20b overlies end element 24 at end 14. Each of the feed members 20, 20a, 20b incorporates a generally U-shaped opening 30 through which an individual I can access a lid L1 from a stack of lids L. The stack of lids L is biased via a compression spring, such as spring 32 toward the lid retainer/removal member 20.

It is to be observed that the lids L are loaded into the body portion 12 in the disclosed embodiment stacked such that the interior side L1-a, which carries a protruding annularly extending flange L1-b, extends toward the member 20. The flange portion L1-b is readily grippable by the individual I for purposes of extracting the lid L1 from the dispenser 10.

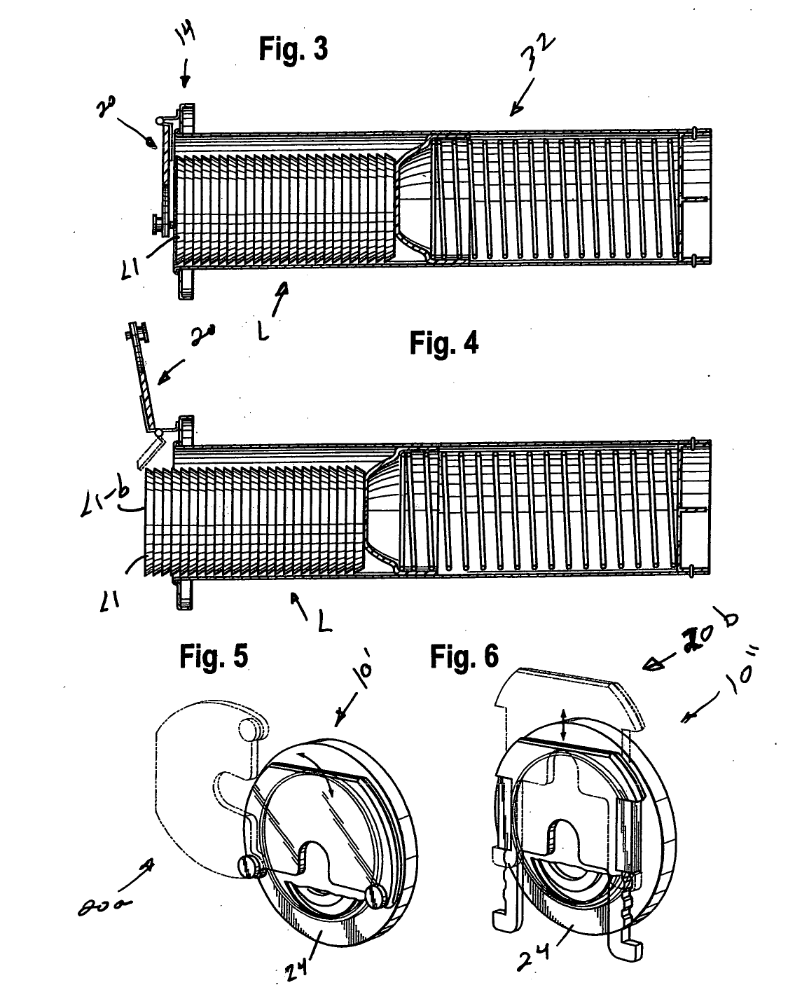

FIGS. 3 and 4 illustrate the stacking configuration wherein the flange L1-b extends toward the member 20 when stacked in the dispenser 10. It will be understood that it comes within the spirit and scope of the present invention to reverse the stacking configuration such that the flange L1-b would extend toward the compression spring 32 with the stacks of lids L loaded into the body or canister 12. The stacking embodiment disclosed in connection with FIGS. 1-4 is a preferred embodiment. As noted above, the reverse stacking configuration comes within the spirit and scope of the present invention.

The dispensing cover 20 in the embodiment of FIGS. 1-4 is hingedly attached, via hinge 40 to the end 24 of the dispenser 10. Retaining screws 42a and b lock the member 20 to the end 24 during normal usage.

An alternate embodiment 10′ is illustrated in FIG. 5. The embodiment 10′ incorporates a pivotally attached dispensing/retaining cover 20a. FIG. 6 illustrates an embodiment 10″ with a slidably attached cover/dispensing member 20b.

It will be understood that a variety of changes or modifications could be made to the disclosed embodiments 10, 10′ or 10″, all without departing from the spirit and scope of the present invention. It will be understood that the exact nature of the material of the lid dispensing covers 20, 20a, 20b is not a limitation of the present invention. They can be formed in various ways of metal or plastic, all without limitation. Similarly, the material of the dispenser 10 and its process of manufacture are not limitations of the present invention. The nature of the spring 32 is also not a limitation of the present invention. All such variations come within the spirit and scope of the invention.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

1. A dispenser comprising:
a product carrying element that defines an open end;
a substantially planar product dispensing member partly covering the open end, the member retains product in the carrying element while exposing a portion of a product in the element, adjacent to the member, for slidable removal therefrom.

2. A dispenser as in claim 1 where the dispensing member terminates in an edge, linear at least in part, that extends across the open end.

3. A dispenser as in claim 2 where the edge includes a concave section between two linear sections.

4. A dispenser as in claim 1 where the product dispensing member is formed of a substantially rigid material.

5. A dispenser as in claim 3 where the product dispensing member is formed of a substantially rigid material.

6. A dispenser as in claim 1 where the product carrying element includes a product biasing spring.

7. A dispenser as in claim 5 where the product carrying element includes a product biasing spring.

8. A dispenser as in claim 7 where the product dispensing member is substantially adjacent to the open end.

9. A dispenser as in claim 8 where the product dispensing member is one of hingedly attached, pivotably attached, slidably attached, or, rotatably attached to the product dispensing member.

10. A dispenser as in claim 1 where the product dispensing member is one of hingedly attached, pivotably attached, slidably attached, or, rotatably attached to the product dispensing member.

11. A dispenser comprising:
a hollow elongated element which has at least a partly open end;
a closure attached to the element, adjacent to the open end, the closure covering the at least partly open end with a surface that terminates at a concave edge.

12. A dispenser as in claim 11 where the concave edge includes first and second spaced-apart linear edge regions joined by a concave region.

13. A dispenser as in claim 12 where the concave edge is symmetrical relative to a centerline.

14. A dispenser as in claim 11 where the concave edge includes a generally U-shaped central region.

15. A dispenser as in claim 14 where the U-shaped central region provides access to the at least partly open end.

16. A dispenser as in claim 11 which includes a dispensable product biasing spring located in the hollow elongated element.

17. A dispenser as in claim 16 where the closure retains a stack of biased product, to be dispensed, in the element and provides for slidable removal of one product at a time past the concave region.

18. A dispenser as in claim 17 where the closure is movable between a first, dispensing, location, and a second, loading, location.

19. A dispenser as in claim 18 where the closure is one of rotable or slidable relative to the open end.
